(19) United States
(12) Patent Application Publication
(10) Pub. No.: US 2018/0083684 A1
(43) Pub. Date: Mar. 22, 2018

(54) CARRIER AGGREGATION ENHANCEMENT

(71) Applicant: INTEL IP CORPORATION, Santa Clara, CA (US)

(72) Inventors: Hong HE, Beijing (CN); Alexei DAVYDOV, Nizhny Novgorod (RU); Seunghee HAN, San Jose, CA (US)

(21) Appl. No.: 15/565,644

(22) PCT Filed: May 6, 2016
(86) PCT No.: PCT/US2016/031299

§ 371 Date: Oct. 10, 2017

Related U.S. Application Data
(60) Provisional application No. 62/160,356, filed on May 12, 2015.

(51) Int. Cl. H04B 7/06; H04W 72/04; H04L 1/00; H04L 5/00

(52) U.S. Cl. CPC H04B 7/0626; H04L 5/001; H04L 1/0027; H04W 72/042

(57) ABSTRACT

A component carrier (CC) selection based aperiodic CSI report trigger configuration may be used to trigger one or more of channel state information (CSI) processes, CCs in cell groups, and/or CSI subframe sets to perform an aperiodic CSI report based on a value of a CSI request field in an uplink DCI format and serving cell information to indicate a serving cell where aperiodic CSI reporting is transmitted according to the detected uplink DCI format or a serving cell where PDCCH conveying the detected uplink DCI format is transmitted.

### CROSS REFERENCE TO RELATED APPLICATIONS

Priority of U.S. Provisional patent application Ser. No. 62/160,356, filed on May 12, 2015, is claimed. Said provisional application is hereby incorporated by reference in its entirety.

### BACKGROUND

Wireless mobile communication technology uses various standards and protocols to transmit data between a base station and a wireless mobile device. In the third generation partnership project (3GPP) long term evolution (LTE) systems, the base station may be an evolved Node B (eNode B or eNB) in a Universal Terrestrial Radio Access Network (UTRAN) or an evolved UTRAN (eUTRAN), which communicates with the wireless mobile device, e.g., a user equipment (UE).

### BRIEF DESCRIPTION OF THE DRAWINGS

The disclosure described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 schematically illustrates an example of a network in accordance with some embodiments.

FIG. 2 schematically illustrates an electronic device circuitry according to some embodiments.

FIG. 3 schematically illustrates an example of carrier aggregation in accordance with some embodiments.

FIG. 4 schematically illustrates an example of an aperiodic CSI report trigger configuration in accordance with some embodiments.

FIG. 5 schematically illustrates a flow chart of one or more processes in accordance with some embodiments.

FIG. 6 schematically illustrates an example of a mobile device in accordance with various embodiments.

FIG. 7 schematically illustrates an exemplary implementation of a mobile device in accordance with some embodiments of FIG. 6.

Reference will now be made to the exemplary embodiments illustrated, and specific language will be used herein to describe the same. It will nevertheless be understood that no limitation of the scope of the disclosure is thereby intended.

### DETAILED DESCRIPTION

Before the present disclosure is disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element.

References in the specification to “one embodiment”, “an embodiment”, “an example embodiment”, etc., indicate that the embodiment described may comprise a particular feature, structure, or characteristic, but every embodiment may not necessarily comprise the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the disclosure may be implemented in hardware, firmware, software, or any combination thereof. Embodiments of the disclosure may also be implemented as instructions stored on a machine-readable medium, which may be read and executed by one or more processors. A machine-readable medium may comprise any mechanism for storing or transmitting information in a form readable by a machine (e.g., a computing device). For example, a non-transitory machine-readable medium may comprise read only memory (ROM); random access memory (RAM); magnetic disk storage media; optical storage media; flash memory devices. For another example, a machine-readable medium may comprise electrical, optical, acoustical or other forms of propagated signals (e.g., carrier waves, infrared signals, digital signals, etc.), and others.

The following description may comprise terms, such as first, second, etc. that are used for descriptive purposes only and are not to be construed as limiting. As used herein, the term “module” may refer to, be part of, or comprise an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable component(s) that provide the described functionality.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter. The following definitions are provided for clarity of the overview and embodiments described below.

In 3GPP radio access network (RAN) LTE systems, a transmission station may be a combination of Evolved universal terrestrial radio access network (E-UTRAN) Node Bs (or may be denoted as evolved Node Bs, enhanced Node Bs, eNodeBs, and/or eNBs), which may communicate with a wireless mobile device, known as a user equipment (UE).

Some embodiments may be used in conjunction with various devices and systems, for example, a user equipment (UE), a mobile device (MD), a wireless station (STA), a personal computer (PC), a desktop computer, a mobile computer, a laptop computer, a notebook computer, a tablet computer, a smart phone, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wireless node, a base station (BS), a wired or wireless router, a wired or wireless modem, a video device, an audio device, an audio-video (A/V) device, a wired or wireless network, a wireless area network, a cellular network, a cellular node, a cellular device, a wireless local area network (WLAN), a multiple input multiple output (MIMO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, vending machines, sell terminals, or the like.

Some embodiments may be used in conjunction with one or more types of wireless communication signals and/or systems, for example, radio frequency (RF), frequency-division multiplexing (FDM), orthogonal FDM (OFDM), single carrier frequency division multiple access (SC-FDMA), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), wireless fidelity (Wi-Fi), Wi-Max, ZigBee™, ultra-wideband (UWB), global system for mobile (GSM), second generation (2G), 2.5G, 3G, 3.5G, 4G, 4.5G, 5G, 6G or future mobile networks, 3GPP, long term evolution (LTE), LTE advanced (LTE-A), Licensed Assisted Access (LAA), high-speed downlink packet access (HSDPA), high-speed uplink packet access (HSUPA), high-speed packet access (HSPA), HSPA+, single carrier radio transmission technology (1×RTT), evolution-data optimized (EV-DO), enhanced data rates for GSM evolution (EDGE), and the like. Other embodiments may be used in various other or future devices, systems and/or networks.

Some embodiments are described herein with respect to an LTE network. However, other embodiments may be implemented in any other suitable cellular network or system, e.g., a GSM network, a 3G cellular network such as a Universal Mobile Telecommunications System (UMTS) cellular system, a 4G cellular network, a 4.5G network, a 5G network, a 6G network or future network or a WiMax cellular network, or the like or other future network.

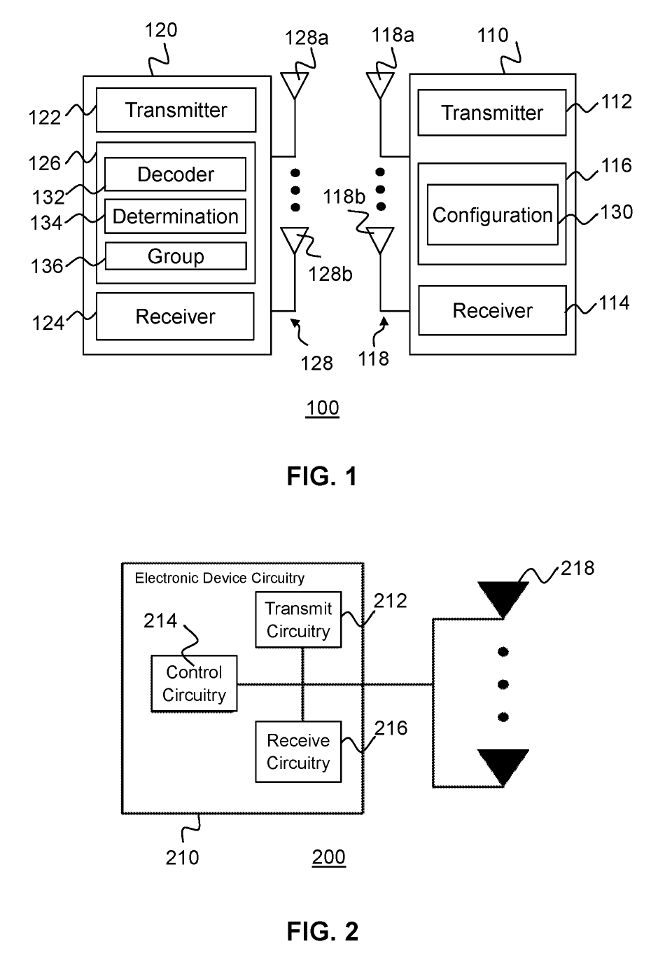

FIG. 1 schematically illustrates a wireless communication network 100 in accordance with various embodiments. The wireless communication network 100 (hereinafter “network 100”) may be an access network of a 3GPP LTE network such as E-UTRAN, 3GPP LTE-A network, 3GPP LAA network, 4G network, 4.5G network, a 5G network, a 6G network or other future communication network, or a WiMax cellular network, HSPA, Bluetooth, WiFi or other type of wireless access networks. The network 100 may comprise one or more wireless communication devices capable of communicating content, data, information and/or signals via one or more wireless mediums, for example, a radio channel, a cellular channel, an RF channel, a wireless-local-area-network (WLAN) channel such as a WiFi channel, and/or the like. In some embodiments, one or more elements of network 100 may optionally be capable of communicating over any suitable wired communication links.

In some embodiments, the network 100 may comprise a base station, e.g., an enhanced node base station (eNB) 110 that may wirelessly communicate with a mobile device or terminal, e.g., a user equipment (UE) 120. In some embodiments, the eNB 110 may be comprised in a radio access network that may comprise one or more cellular nodes, e.g., an eNB, a Node B, a base station (BS), a base transceiver station (BTS), and/or the like.

In some embodiments, from Rel-10 of 3GPP specifications, carrier aggregation (CA) may be supported in LTE advanced. CA may be used in International Mobile Telecommunications-Advanced (IMT-Advanced) and/or maintain backward compatibility with Rel-8 and Rel-9 LTE. For example, Rel-10 CA may permit LTE radio interface to be configured to aggregate with, e.g., 5 carriers to achieve wider transmission bandwidth.

In 3GPP Release 13, LTE unlicensed spectrum and/or licensed spectrum may be used to cope with an increase in mobile data consumption, which may be known as License Assisted Access (LAA) in 3GPP. For example, LTE WLAN that may operate in, e.g., 5 GHz band may support, e.g., 80 MHz in LTE WLAN and/or e.g., 160 MHz in IEEE 802.11ac. LTE Carrier Aggregation (CA) enhancement beyond, e.g., 5 carriers may be used to enable utilization of at least similar bandwidth with LAA as IEEE 802.11ac. In some embodiments, up to 32 component carriers (CCs) or other number of CCs may be used for downlink and/or uplink.

In some embodiments, UE 120 may be a subscriber station that may be configured to utilize radio resources across one or more carriers such as in a CA scheme. In some embodiments, UE 120 may be configured to utilize CA, wherein one or more CCs may be aggregated for a communication between eNB 110 and UE 120. For example, UE 120 may connect with a primary serving cell (PCell) of eNB 110 that may utilize a primary CC. For another example, UE 120 may connect with one or more secondary serving cells (SCells) of eNB 110 that may utilize one or more secondary CCs. In various embodiments, UE 120 may communicate in one or more wireless communication networks, including 3GPP LTE network, 3GPP LTE-U network, 3GPP LTE-A network, 3GPP LAA network, a 5G network, a 6G network or other future network or other wireless networks such as a 4G network, a 4.5G network, a WiMax cellular network, WiMAX, HSPA, Bluetooth, WiFi, or the like.

In some embodiments, eNB 110 and/or UE 120 may each comprise an LTE system that may utilize a licensed spectrum for a corresponding LTE service provider (or operator). The LTE system may operate in a licensed spectrum, e.g., LTE in Licensed Spectrum or simply LTE. The LTE system may operate in an unlicensed spectrum, e.g., LTE in Unlicensed Spectrum or LTE-U. In some embodiments, an LTE system may operate in a licensed spectrum and/or an unlicensed spectrum to increase a data throughput of the LTE system. The LTE system that may integrate LTE and LTE-U using carrier aggregation (CA) technology may be called as Licensed-Assisted Access (LAA) using LTE, or simply LAA.

Referring to FIG. 1, eNB 110 may comprise one or more of a controller 116, a transmitter 112, a receiver 114 and one or more antennas 118. The eNB 110 may optionally comprise other hardware components and/or software/firmware components, e.g., a memory, a storage, an input module, an output module, one or more radio modules and/or one or more digital modules, and/or other components. Transmitter 112 may be configured to transmit signals to UE 120 via one or more antennas 118. Receiver 114 may be configured to receive signals from UE 120 via one or more antennas 118.

Controller 116 may be coupled with transmitter 112 and/or receiver 114. In some embodiments, controller 116 may control one or more functionalities of eNB 110 and/or control one or more communications performed by eNB 110. In some embodiments, controller 116 may execute instructions of software and/or firmware, e.g., of an operating system (OS) of eNB 110 and/or of one or more applications. Controller 116 may comprise or may be implemented using suitable circuitry, e.g., controller circuitry, scheduler circuitry, processor circuitry, memory circuitry, and/or any other circuitry, which may be configured to perform at least part of the functionality of controller 116. In some embodiments, one or more functionalities of controller 116 may be implemented by logic, which may be executed by a machine and/or one or more processors.

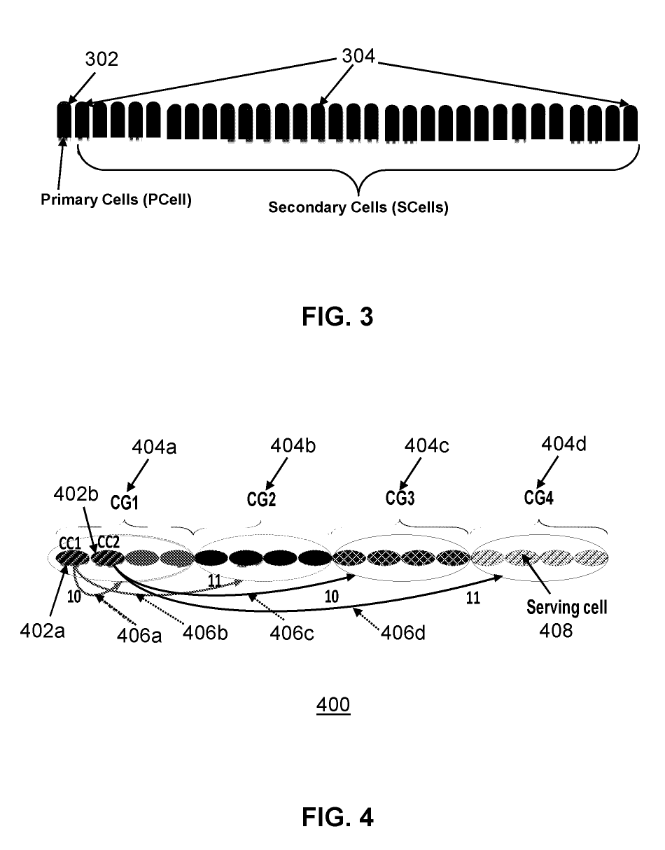

In some embodiments, controller 116 may comprise a configuration module or unit 130 that may be coupled to one or more other components in controller and/or eNB 110. In some embodiments, configuration module 130 may configure one or more aperiodic CSI report trigger configurations for a set of one or more CCs or CSI processes and/or one or more pairs of CSI process(es) and CSI subframe set(s). In some embodiments, configuration module 130 may perform one or more configurations to trigger one or more aperiodic CSI reports or feedbacks, e.g., as described below with regard to FIGS. 3 to 5 or other embodiments in the disclosure. While FIG. 1 illustrate an example of a configuration module or unit 130, in some embodiments, the configuration module or unit 130 may be implemented by the controller 116 or by a circuitry or other element in eNB 110.

In some embodiments, the configuration module 130 may configure a combination of a serving cell and/or a respective value of CSI request field to a UE, e.g., 120, to trigger a corresponding CSI report for a CSI reporting subject that may include, for example, one or more CCs and/or a set of CSI processes, and/or a combination of {CSI process(es), CSI subframe set(s)} pair(s). The eNB 110 may transmit a physical downlink control channel (PDCCH) or Enhanced PDCCH (EPDCCH) with a CSI request field in downlink control information (DCI) with an uplink DCI format set to trigger an aperiodic CSI report. The DCI may be transmitted to UE 120 in a first cell and may indicate that the aperiodic CSI report is to be transmitted to eNB 110 in a second cell, which may be the same or different from the first cell. In some embodiments, the configuration module 130 may configure the serving cell where PDCCH with the detected uplink DCI format is transmitted for an A-CSI report triggering. In some embodiments, the ‘DCI format’, as used herein, may be interpreted as DCI having a format in compliance with, e.g., one or more 3GPP technical specifications. A transmitter 112 may transmit to UE 120 the PDCCH/EPDCCH with DCI having a CSI request field set to a corresponding value for the configured serving cell to trigger an intended A-CSI report. The value of the CSI request field in conjunction with either the serving cell on which the DCI is transmitted or the serving cell on which the A-CSI report is to be transmitted may trigger an A-CSI report with respect to the CSI reporting subject.

In some embodiments, the configuration module 130 may configure a serving cell that is scheduled to transmit an aperiodic CSI report or feedback on a physical uplink shared channel (PUSCH) based on the DCI In some embodiments, the receiver 124 may be configured to receive the PUSCH transmission that may comprise the aperiodic CSI report/feedback on the configured serving cell from UE 120. In some embodiments, the CSI request field in the uplink DCI format may comprise a value associated with the serving cell where the PUSCH to carry the aperiodic CSI report/feedback is transmitted based on the uplink DCI format.

In some embodiments, transmitter 112 may transmit to UE 120 one or more other configurations relating to various aspects associated with an aperiodic CSI report/feedback, e.g., via radio resource control (RRC), e.g., as described below with regard to FIGS. 3 to 5 or other embodiments in the disclosure.

Referring to FIG. 1, in some embodiments, UE 120 may comprise a controller 126, a transmitter 122, a receiver 124 and/or one or more antennas 128. UE 120 may comprise other hardware components and/or software/firmware components, e.g., a memory, a storage, an input unit, an output unit and/or any other components. Transmitter 122 may transmit signals to eNB 110 via one or more antennas 128. Receiver 124 may receive signals from eNB 110 via one or more antennas 128.

In some embodiments, controller 126 may be coupled to receiver 124 and/or transmitter 122. In some embodiments, controller 126 may control one or more functionalities of UE 120 and/or control one or more communications performed by UE 120. In some embodiments, controller 126 may execute instructions of software and/or firmware, e.g., of an operating system (OS) of UE 120 and/or of one or more applications. Controller 126 may comprise or may be implemented using suitable circuitry, e.g., controller circuitry, scheduler circuitry, processor circuitry, memory circuitry, and/or any other circuitry, which may be configured to perform at least part of the functionality of processor 12. In some embodiments, one or more functionalities of controller 126 may be implemented by logic, which may be executed by a machine and/or one or more processors.

In some embodiments, controller 126 may comprise a central processing unit (CPU), a digital signal processor (DSP), a graphic processing unit (GPU), one or more processor cores, a single-core processor, a dual-core processor, a multiple-core processor, a microprocessor, a host processor, a controller, a plurality of processors or controllers, a chip, a microchip, one or more circuits, circuitry, a baseband circuitry, a radio frequency (RF) circuitry, a logic unit, an integrated circuit (IC), an application-specific IC (ASIC), or any other suitable multi-purpose or specific processor or controller and/or any combination thereof.

In some embodiments, receiver 124 may be configured to receive from eNB 110 downlink signaling, e.g., the PDCCH with the uplink DCI format transmitted on a serving cell configured by eNB 110.

In some embodiments, controller 126 may comprise a decoder or a decoding module or unit

132 that may be coupled to one or more other components in the controller 126 and/or UE 110. In some embodiments, the decoder 132 may be configured to decode the received uplink DCI format to obtain a value of a CSI request field in the uplink DCI format, e.g., as described with regard to FIGS. 3 to 5 or other embodiments in the disclosure. In some embodiments, the value of the CSI request field may be associated with the serving cell where the PDCCH to carry the uplink DCI format is transmitted or the serving cell where the PUSCH to carry the aperiodic CSI report/feedback in a manner that may identify a CSI reporting subject for the aperiodic CSI report.

In some embodiments, the controller 126 may comprise a circuitry or unit 134 that may be coupled to one or more other components in the controller 126 and/or UE 110. In some embodiments, the determination module 134 may determine a set of one or more CCs or CSI processes and/or one or more pairs of CSI process(es) and CSI subframe set(s) for one or more aperiodic CSI reports/feedbacks based on the serving cell information and/or the value of the CSI request field in the uplink DCI format, e.g., as described below with regard to FIGS. 3 to 5 and/or other embodiments in the disclosure. For example, determination module 134 may access configuration information that associates a plurality of combinations of serving cells and values of CSI request fields to a corresponding plurality of sets of CCs, CSI processes, or CSI subframe sets; and determine, for the aperiodic CSI report, the set of CCs, the CSI process, or the CSI subframe set based on the configuration information.

In some embodiments, the controller 126 may comprise a group module 136 to maintain the group information associated with one or more serving cells or CCs that may be grouped into one or more cell groups (CGs). In some embodiments, a group module in controller 116 or configuration module 130 of eNB 110 may control grouping of the one or more serving cells or CCs.

In some embodiments, transmitter 122 may be configured to transmit one or more aperiodic CSI reports/feedbacks for a set of one or more CCs or CSI processes and/or one or more pairs of CSI process(es) and CSI subframe set(s) based on the uplink DCI format and serving cell information, e.g., as described below with regard to FIGS. 3 to 5 or other embodiments in the disclosure.

In some embodiments, transmitter 112 may comprise, or may be coupled with one or more antennas 118 of eNB 110 to communicate wirelessly with other components of the wireless communication network 100, e.g., UE 120. Transmitter 122 may comprise, or may be coupled with one or more antennas 128 of UE 120 to communicate wirelessly with other components of the wireless communication network 100, e.g., eNB 110. In some embodiments, transmitter 112 and/or transmitter 122 may each comprise one or more transmitters, one or more receivers, one or more transmitters, one or more receivers and/or one or more transceivers that may be able to send and/or receive wireless communication signals, radio frequency (RF) signals, frames, blocks, transmission streams, packets, messages, data items, data, information and/or any other signals.

In some embodiments, transmitter 122 may support a WLAN communication for UE 120. For example, transmitter 122 may perform functionality of one or more stations, e.g., WiFi stations, WLAN stations, and/or millimeter Wave (mmWave) stations or the like.

In some embodiments, the antennas 118 and/or the antennas 128 may comprise any type of antennas suitable to transmit and/or receive wireless communication signals, RF signals, blocks, frames, transmission streams, packets, messages, data items and/or data. For example, the antennas 118 and/or the antennas 128 may comprise any suitable configuration, structure and/or arrangement of one or more antenna elements, components, units, assemblies and/or arrays. In some embodiments, the antennas 118 and/or the antennas 128 may implement transmit and/or receive functionalities using separate transmit and/or receive antenna elements. In some embodiments, the antennas 118 and/or the antennas 128 may implement transmit and/or receive functionalities using common and/or integrated transmit/receive elements. The antenna may comprise, for example, a phased array antenna, a single element antenna, a dipole antenna, a set of switched beam antennas, and/or the like.

In some embodiments, UE 120 may comprise two antennas, e.g., antennas 128a and 128b, or any other number of antennas, e.g., one or more than two antennas. In some embodiments, eNB 110 may comprise two antennas, e.g., antennas 118a and 118b, or any other number of antennas, e.g., one or more two antennas.

In some embodiments, eNB 110 and/or UE 120 may comprise one or more input units (not shown) and/or one or more output units (not shown). For example, one or more input units may comprise a keyboard, a keypad, a mouse, a touch-screen, a touch-pad, a track-ball, a stylus, a microphone, or any other pointing/input unit or device. For example, one or more output units may comprise a monitor, a screen, a touch-screen, a flat panel display, a Cathode Ray Tube (CRT) display unit, a Liquid Crystal Display (LCD) display unit, a plasma display unit, one or more audio speakers or earphones, or any other output unit or device.

In some embodiments, UE 120 may comprise, for example, a mobile computer, a mobile device, a station, a laptop computing device, a notebook computing device, a netbook, a tablet computing device, an Ultrabook™ computing device, a handheld computing device, a handheld device, a storage device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a mobile phone, a cellular telephone, a PCS device, a mobile or portable GPS device, a DVB device, a wearable device, a relatively small computing device, a non-desktop computer, a “carry small live large” (CSLL) device, an ultra mobile device (UMD), an ultra mobile PC (UMPC), a mobile internet device (MID), an “Origami” device or computing device, a video device, an audio device, an audio/video (A/V) device, a gaming device, a media player, a smartphone, a mobile station (MS), a mobile wireless device, a mobile communication device, a handset, a cellular phone, a mobile phone, a personal computer (PC), a handheld mobile device, an universal integrated circuit card (UICC), a customer premise equipment (CPE), or other consumer electronics such as digital cameras and the like, personal computing accessories and existing and future arising wireless mobile devices which may be related in nature and to which the principles of the embodiments could be suitably applied.

While FIG. 1 illustrates some components of eNB 110, in some embodiments, the eNB 110 may optionally comprise other suitable hardware, software and/or firmware components that may be interconnected or operably associated with one or more components in the eNB 110. While FIG. 1 illustrates some components of UE 120, in some embodiments, UE 120 may comprise other suitable hardware, software and/or firmware components that may be interconnected or operably associated with one or more components in UE 120. While FIG. 1 illustrates one or more components in eNB 110 and/or UE 120, eNB 110 and/or UE 120 may each comprise one or more radio modules or units (not shown) that may modulate and/or demodulate signals transmitted or received on an air interface, and/or one or more digital modules or units (not shown) that may process signals transmitted and received on the air interface.

While FIG. 1 illustrates one or more components, e.g., configuration module 130, in eNB 110, in some embodiments, one or more functions or processes of the components may be provided by the controller 116 or by, e.g., transmitter 112, receiver 114, a baseband circuitry, a processor or other components of eNB 110. While FIG. 1 illustrates one or more components, e.g., decoder 132 and/or determination module 134, in UE 120, in some embodiments, one or more of functions or processes of the components may be provided by the controller 126 or by, e.g., transmitter 112, receiver 114, a baseband circuitry or a processor, or other component of the UE 120. While FIG. 1 illustrates examples of a determination module or unit 134 and/or a grouping module or unit 136, in some embodiments, the determination module or unit 134 and/or the grouping module or unit 136 may be implemented in the same circuitry, controller, module, unit and/or other element in UE 120.

FIG. 2 illustrates an electronic device circuitry 200 according to an embodiment. The electronic device circuitry 200 may be eNB circuitry of, for example, eNB 110, UE circuitry of, for example, UE 120, or other type of circuitry in accordance with various embodiments. For example, the electronic device circuitry 200 may communicate using one or more wireless communication standards such as 3GPP LTE, 3GPP LTE-A, 3GPP LTE-U, WiMAX, HSPA, Bluetooth, WiFi, 5G standards, 6G standards or other wireless standards in various embodiments. The electronic device circuitry 200 may communicate in a wireless local area network (WLAN), a wireless personal area network (WPAN), and/or a wireless wide area network (WWAN) or other network in various embodiments.

In various embodiments, the electronic device circuitry 200 may be, or may be incorporated into or otherwise a part of, an eNB, a UE, or other type of electronic device. The electronic device circuitry 200 may comprise radio transmit circuitry 212 and receive circuitry 216 coupled to control circuitry 214. In some embodiments, the transmit circuitry 212 and/or receive circuitry 216 may be elements or modules of a transceiver circuitry. The electronic device circuitry 200 may be coupled with one or more plurality of antenna elements of one or more antennas 218. The electronic device circuitry 200 and/or the components of the electronic device circuitry 200 may be configured to perform operations similar to those described herein.

In some embodiments, the electronic device circuitry 200 may be part of or comprise an application specific integrated circuit (ASIC), an electronic circuit, a processor (shared, dedicated, or group), and/or memory (shared, dedicated, or group) that execute one or more software and/or firmware programs, a combinational logic circuit, and/or other suitable hardware components that provide the described functionality. In some embodiments, the electronic device circuitry 200 may be implemented in, or functions associated with the circuitry may be implemented by, one or more software and/or firmware modules.

While FIG. 2 illustrates some components of electronic device circuitry 200, in some embodiments, eNB 110 may optionally comprise other suitable hardware, software and/or firmware components that may be interconnected or operably associated with one or more components in the electronic device circuitry 200, e.g., one or more radio modules or units (not shown) that may modulate and/or demodulate signals transmitted or received on an air interface, and/or one or more digital modules or units (not shown) that may process signals transmitted and received on the air interface.

FIG. 3 illustrates an example of carrier aggregation in accordance with some embodiments. In some embodiments, an LTE licensed carrier may be served as a primary cell or PCell, e.g., 302 in LAA. In some embodiments, one or more LTE-U carriers may be served as secondary cell(s) or SCell(s), e.g., 304. In some embodiments, an SCell 304 may be indexed with an SCell index. For example, the one or more SCells 304 may be indexed as, e.g., SCell 1 to SCell 31, based on a number of secondary cells in carrier aggregation. While FIG. 3 illustrates an example of a PCell 302 and 31 SCells 304, in some embodiments, a different number of PCells and/or SCells may be aggregated based on a carrier aggregation mode.

In some embodiments, a component carrier (CC) in carrier aggregation may support one or

more communication channels based on 3GPP LTE-A. For example, a CC may support one or more communication channels to carry information between UE 120 and eNB 110. A CC may include one or more uplink and/or downlink subframes to carry information between eNB 110 and UE 120. For example, one or more radio bearers may be used to implement a quality of service (QoS) supporting in an air interface. In carrier aggregation, a radio bearer may be transmitted and/or received on one or more serving cells.

In some embodiments, LTE-A may support one or more CSI report modes, e.g., a periodic CSI report on a PUCCH and/or an aperiodic report on a PUSCH or other CSI report mode.

In some embodiments, the periodic CSI report may be used to indicate a channel quality of a downlink channel at UE 120, e.g., on a long-term basis. The periodic CSI may be provided by UE 120 in accordance with a predefined report time schedule that may be configured by the serving cell, e.g., eNB 110, via higher layer signaling. In some embodiments, the higher layer signaling may comprise, e.g. Radio Resource Control (RRC) signaling. In some embodiments, the aperiodic CSI report may be used to provide a more detailed report in a single instance based on a dynamic CSI request triggered by the serving cell through an uplink DCI format and/or a Random Access Response Grant.

In some embodiments, the aperiodic CSI report may be triggered by a CSI request field, e.g., 2 bits or other number of bits, in carrier aggregation. In some embodiments, the CSI request field may be used to trigger, e.g., 2 sets of CCs for CSI feedback on PUSCH in a time-division multiplexing (TDM) manner. In some embodiments, a maximum number of the serving cells per each CSI request field may comprise, e.g., 5 or 8, CCs to keep the same computational complexity and/or channel coding procedures as uplink control information (UCI). For example, 32 CCs may be grouped into more than two CC sets, e.g., four sets each with 8 CCs to trigger Aperiodic-CSI (A-CSI) feedback. In some embodiments, a CSI request field with 3 or 4 bits or more bits may be implemented to provide one or more benefits in terms of maximum number of CCs that may be triggered by a single uplink DCI format but at a cost of increasing a DCI format size and/or may impact DCI detection performance.

In some embodiments, in addition to CSI request field in uplink DCI format, CC(s) or serving cell information may be further utilized to trigger aperiodic CSI report(s) for different set of one or more of CCs or serving cells, or CSI processes and/or CSI subframe sets. In some embodiments, subframe information may be additionally used to trigger the aperiodic CSI report similarly. In one embodiment, the subframes with even indices may be used for A-CSI reporting triggering; while the subframes with odd indices may be used for A-CSI reporting triggering. For example, the subframe information may be used in conjunction with the CSI request field in uplink DCI format, CC(s) or serving cell information may be utilized to trigger aperiodic CSI report(s) for different set of one or more of CC(s) or serving cell(s), or CSI process(es) and/or CSI subframe set(s). For example, for a UE configured with one or more sets of CCs, e.g., more than two, a current DCI format size may be preserved and flexibility with a finer A-CSI trigger granularity in a CC-domain may be provided. For example, an A-CSI trigger granularity in CC-domain may relate to a number of one or more CCs for an A-CSI report. In some embodiments, the CC or serving cell information that can be utilized to trigger an A-CSI report may be one or more CCs or serving cells where PUSCH conveying the triggered A-CSI report is scheduled or the one or more CCs or serving cells where a physical downlink control channel (PDCCH) containing a valid CSI request field is transmitted. In some embodiments, a flexible trigger of CSI feedback for Rel-13 may still maintain the same size of DCI format and/or CSI request field.

In some embodiments, configured CC information and/or a CSI request field value of an uplink grant in an LTE system may be utilized for an aperiodic CSI report for, e.g., 32 CCs or other number of CCs, to avoid an increasing number of bits in CSI request field and/or to preserve the same A-CSI report granularity in CC domain. In some embodiments, a smaller payload size may be used to maintain an uplink grant detection performance, e.g., similar to or same as Rel-12 LTE system.

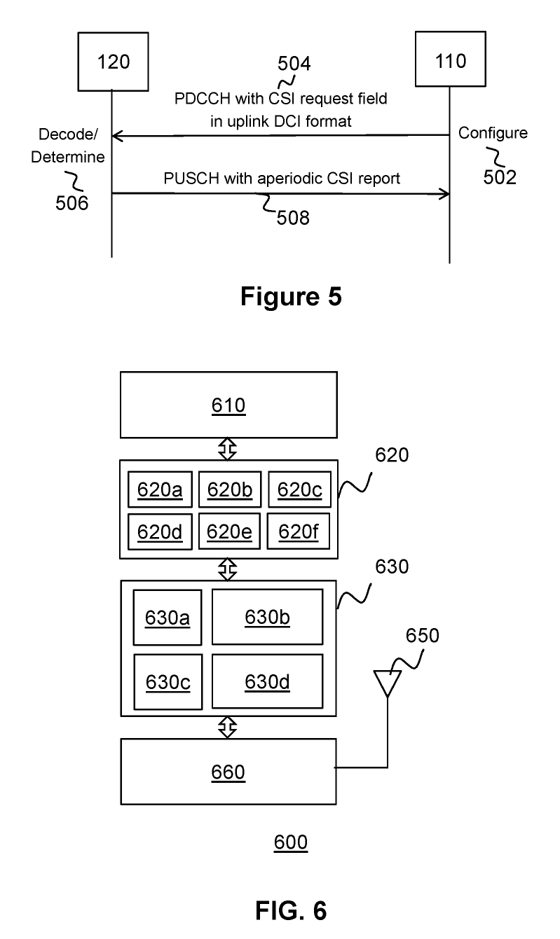

In some embodiments, CC or subframe information may be used to provide a flexibility to trigger an aperiodic CSI report for CA and/or maintain a CSI request field in DCI format for an increased number of CCs (e.g., 32 CCs). In some other embodiments, the CC or subframe information may be used to provide a similar or same A-CSI report granularity in CC domain for CA without increasing or minimizing a number of bits in CSI request field. The CC or subframe information that may be used to trigger an aperiodic CSI report may relate to one or more CCs or subframes where a PDCCH containing a CSI request field (e.g., 504 of FIG. 5) is transmitted or where a PUSCH containing A-CSI report (e.g., 508 of FIG. 5) is transmitted or scheduled.

In some embodiments, a CC-selection-based aperiodic CSI report trigger may be used. For example, UE 120 may determine one or more in {CSI process(es), CC(s) in CG(s), CSI subframe sets} to perform an aperiodic CSI report based on a value of a CSI request field in an uplink DCI format and serving cell information.

In some embodiments, the serving cell information may:

be a first serving cell where an aperiodic CSI report is transmitted based on the detected uplink DCI format (referred to as “Option 1”); or

be a second serving cell where PDCCH conveying the detected uplink DCI format is transmitted (referred to as “Option 2”).

In some embodiments, the first serving cell and the second serving cell may relate to the same serving cell in case of self-scheduling. In some other embodiments, the first serving cell and the second serving cell may refer to different serving cells in case of cross-carrier scheduling.

For different transmission mode (TM) configurations, an aperiodic CSI report may be triggered in some embodiments.

In some embodiments, in response to UE 120 being configured in transmission mode 1-9 for all serving cells and/or UE 120 not being configured with csi-SubframePatternConfig-r12 for any serving cell, eNB 110 may configure various combinations of <One serving cell, One value of CSI request field> by RRC message to trigger A-CSI reports for different sets of serving cells or CCs.

For example, if UE 120 is configured with a combination of <one serving cell, one value of CSI request field>, in response to decoding an uplink DCI format with a CSI request field set as value “M” and/or in response to decoding the detected uplink DCI format transmitted on serving cell “c” in Option 2 or in response to decoding the uplink DCI format to schedule a PUSCH transmission for A-CSI report on serving cell “c” in Option 1, an aperiodic CSI report for an associated set of serving cells or CCs may be triggered subject to the detected combination of “M” and “c”.

For example, eNB 110 may configure an association between a combination of <one serving cell, one value of CSI request field> and a CC set to perform an A-CSI report may be configured as follows:
<CC “x”, 10> may be used to trigger an A-CSI report for a first set of one or more serving cells or CCs configured by higher layers.
<CC “x”, 11> may be used to trigger an A-CSI report for a second set of one or more serving cells or CCs configured by the higher layers.
<CC “y”, 10> may be used to trigger an A-CSI report for a third set of one or more serving cells or CCs configured by the higher layers.
<CC “y”, 11> may be used to trigger an A-CSI report for a fourth set of one or more serving cells or CCs by higher layers.
. . . .

In some embodiments, CC “x” or CC “y” may represent a CC in the CC set where an aperiodic CSI report is transmitted based on the detected uplink DCI format or where PDCCH conveying the detected uplink DCI format is transmitted.

In some embodiments, other CC information and/or other CSI request field value may be used to trigger A-CSI report for a set of serving cells or CCs associated with the other CC.

Table 1 illustrates an example of a CSI request with uplink DCI format in a UE specific search space.

TABLE 1
CSI Request field with uplink DCI
format in UE specific search space

| Value of CSI request field | |
|---|---|
| on serving cell ‘c’ or for | |
| serving cell “c” | Description |
| ‘00’ | No aperiodic CSI report is triggered |
| ‘01’ | Aperiodic CSI report is triggered for |
| | serving cell c |
| ‘10’ | Aperiodic CSI report is triggered for a |
| | first set of serving cells associated |
| | with serving cell ‘c’ |
| ‘11’ | Aperiodic CSI report is triggered for a |
| | second set of serving cells associated |
| | with serving cell ‘c’ |

As shown in Table 1, in some embodiments, a CSI request field value of “10” and a serving cell “c” may be used to trigger an aperiodic CSI report for a first set of one or more serving cells associated with the serving cell “c”. In some embodiments, the CSI request field value “11” and the serving cell “c” may trigger an aperiodic CSI report for a second set of one or more serving cells associated with the serving cell “c”, e.g., as described previously in Option 1 or Option 2.

Referring FIG. 4, an example of an A-CSI report trigger configuration 400 is illustrated in accordance with some embodiments. FIG. 4 illustrates examples of CC sets associated with combinations of <One serving cell, one value of CSI request field>, wherein x=1 and y=2. In some embodiments, one or more serving cells may be grouped into one or more cell groups (CGs). As shown in FIG. 4, in some embodiments, UE 120 may be configured with, e.g., a set of 16 CCs that may be grouped into four CGs indexed as CG1 404a, CG2 404b, CG3 404c and CG4 404d. In some embodiments, a different number of CCs and/or a different number of CGs may be configured for UE 120. In some embodiments, a CC may be served as a serving cell, e.g., 408. In some embodiments, eNB 110 may configure one or more combinations of <One serving cell, one value of CSI request field> relating to the A-CSI report trigger configuration 400 as follows:

<CC1 in CG1, 10> may be configured by higher layers to trigger an A-CSI report for a first set of CCs in CG1 404a;

<CC1 in CG1, 11> may be configured by the higher layers to trigger an A-CSI report for a second set of CCs in CG2 404b;

<CC2 in CG1, 10> may be configured by the higher layers to trigger an A-CSI report for a third set of CCs of CG3 404c; and

<CC2 in CG1, 11> may be configured by the higher layers to trigger an A-CSI report for a fourth set of CCs in CG4 404d.

Referring to FIG. 4, in some embodiments, CC1 402a in CG1 404a may be configured to transmit an uplink grant 406a that may comprise a CSI request field with a value of “10” to trigger an A-CSI report or feedback for a first set of CCs in CG1 404a.

In some embodiments, CC1 402a in CG1 404a may be configured to transmit an uplink grant 406b that may comprise a CSI request field with a value of “11” to trigger an A-CSI report or feedback for a second set of CCs of CG2 404b.

In some embodiments, CC2 402b in CG1 404a may be configured to transmit an uplink grant 406b that may comprise a CSI request field with a value of “10” to trigger an A-CSI report or feedback for a third set of CCs of CG3 404c.

In some embodiments, CC2 402b in CG1 404a may be configured to transmit an uplink grant 406b that may comprise a CSI request field with a value of “11” to trigger an A-CSI report or feedback for a fourth set of CCs of CG4 404d.

In some embodiments, higher layers, e.g., eNB 110, may not transmit CC index(es) of a combination over the air to reduce signaling overhead. For example, one or more rules may be specified to implicitly associate one or more CCs with a CC set to trigger an A-CSI report.

In some embodiments, eNB 110 may configure an association between a CC “k” and a (k+1)th set of CCs or serving cells. For example, a CC “k” may be used to trigger an A-CSI report for the (k+1)th set of one or more serving cells, where k=N mod L, N denote a total number of CCs and/or L denote a total number of CC sets configured by RRC for a UE, e.g., 120. In some other embodiments, if UE 120 is configured with a number of 16 CCs and 4 CC sets, e.g., N=16 and L=4, any cell of <CC0, CC4, CCB, CC12> may be used with a CSI request field value of “10” to trigger an A-CSI report for a first set of CCs configured by higher layer, e.g., eNB 110. In some embodiments, other A-CSI report configuration may use other CC and a CSI request field value to trigger an A-CSI report for other set of one or more CCs.

For another example, the serving cells of UE 120 may be grouped into one or more cell groups (CGs). In some embodiments, the A-CSI report trigger mechanism may be applied independently within each CG. For example, if the CSI request field for CG “X” may be set with a respective value (e.g. “10” or “11”), any serving cell or CC belonging to the CG ‘X’ may be used to trigger an A-CSI report or feedback for a set of CCs within the CG ‘X’. In some embodiments, if a respective CSI request field in an uplink format is set to trigger an A-CSI report, UE 120 may perform the A-CSI report for one or more serving cells in an associated CG in response to decoding the uplink format to schedule a PUSCH on any serving cell within the associated CG (Option 1) or in response to decoding the uplink DCI format transmitted on any serving cell within the associated CG (Option 2). In some embodiments, A-CSI report a cross one or more CGs may not be supported.

In some embodiments, UE 120 may be configured in TM10 for at least one serving cell and/or UE 120 may not be configured with CSI subframe set for any serving cell. For example, in TM 10, a CC may be configured with a plurality of CSI processes, e.g., coordinated multiple points transmission/reception (CoMP). In some embodiments, the A-CSI report as described previously may be used. In some embodiments, the “set of serving cells” in Table 1 may be replaced by “set of CSI process(es)” for each combination of <serving cell ‘c’, CSI request field value ‘M’>.

For example, <CC1 in CG1, 10> may be configured by higher layers, e.g., eNB 110, to trigger an A-CSI report for a first set of CSI process(es) of CG1. For another example, <CC1 in CG1, 11> may be configured by higher layers to trigger an A-CSI report for a second set of CSI process(es) of CG1, etc. In some embodiments, a combination between a CC in a second CG and a CSI request field value may be configured by higher layers to trigger an A-CSI report for a set of CSI process(es) of the second CG.

In some other embodiments, UE 120 may be configured in TM10 for at least one serving cell and/or UE 120 may be configured with one or more CSI subframe sets for at least one serving cell. In some embodiments, the A-CSI report as described previously may be used. For example, the “set of serving cells” in Table 1 may be replaced by “set of CSI process(es) and/or {CSI process(es), CSI subframe set} pair(s)” for each combination of <serving cell ‘c’, CSI Request field value ‘M’>. For example, an association between a CC and a CSI request field value/a serving cell may be configured by higher layers to trigger an A-CSI report for a set of CSI process(es) and/or a pair of CSI process(es) and a CSI subframe set. For example, a combination of <CC1, CSI request field value “10”> may be configured by higher layers, e.g., eNB 110, to trigger an aperiodic CSI report associated with a combination of {a first set of CSI processes, a first CSI subframe set}.

In some embodiments, an A-CSI report may be triggered if UE 120 is configured with more than X CGs, e.g., X=2, which may not be required in some embodiments. In some other embodiments, UE 120 may not receive more than one aperiodic CSI report requests for a subframe, which may not be required in some embodiments.

FIG. 5 illustrates an example of one or more processes in accordance with some embodiments. In some embodiments, the one or more processes may be used by eNB 110 and/or UE 120 that may be configured with carrier aggregation in a long term evolution (LTE), LTE-advanced (LTE-A), e.g., LAA, and/or 5G RAT, 6G RAT, or any other future RAT.

Referring to FIG. 5, in some embodiments, at 502, eNB 110 may configure an A-CSI report trigger configuration for UE 120, e.g., via configuration module 130. For example, eNB 110 may configure serving cell information and/or an uplink DCI format to trigger an A-CS report. For example, eNB 110 may configure the serving cell information and/or a value of a CSI request field in the uplink DCI format.

In some embodiments, eNB 110 may configure the serving cell and/or the value of the CSI request field to trigger one or more A-CSI reports for different sets of serving cells, or CC(s) or CSI process(es) or pair(s) of <CSI process(es), CSI subframe set(s)> via RRC. In some embodiments, eNB 110 may configure one or more combinations of the serving cell and the value of CSI request field, e.g., <One serving cell, One value of CSI request field>, to trigger A-CSI reports for different sets of serving cells via RRC, e.g., as described previously with regard to Table 1. In some embodiments, eNB 110 may configure A-CSI report trigger configuration for different transmission mode (TM), e.g., UE 120 is configured in TM 1-9 for all serving cells and/or UE 120 is not configured with csi-SubframePatternConfig-r12.

For example, eNB 110 may configure the serving cell information to indicate a serving cell “c” where a PUSCH to carry an aperiodic CSI report may be transmitted based on the uplink DCI format (Option 1), or where a PDCCH with the uplink DCI format is transmitted (Option 2), e.g., as described previously with regard to Options 1 and 2. In some embodiments, eNB 110 may configure the uplink DCI format to comprise a CSI request field with a value “M”, e.g., “10” and/or “11”, that may indicate to trigger an A-CSI report for a set of serving cell(s) associated with the serving cell “c”. In some embodiments, eNB 110 may configure the serving cell information and/or the value of CSI request field to indicate, e.g., whether an aperiodic CSI report is triggered and/or to trigger the aperiodic CSI report for an associated set of serving cell(s) or CC(s).

In some embodiments, eNB 110 may configure an associated set of serving cell(s) for an aperiodic CSI report, e.g., by RRC. In some embodiments, eNB 110 may configure an association between a combination <One serving cell, One value of CSI request field> and a CC set for aperiodic CSI report.

For example, eNB 110 may configure an association between <One serving cell, One value of CSI request field> and a set of CCs or serving cells. For example, eNB 110 may configured an A-CSI report trigger configuration, e.g., as described above with regard to FIG. 4. For example, eNB 110 may configure one or more combinations of <CC “x”, 10>, <CC “x”, 11>, <CC “y”, 10>, <CC “y”, 11>, etc., to each trigger an A-CSI report associated with a set of CCs or serving cells associated with the CC “x” or CC “y”, as described previously. For another example, eNB 110 may configure one or more combinations of <CC1 in CG1, 10>, <CC1 in CG1, 11>, <CC2 in CG1, 10>, and/or <CC2 in CG1, 11> and a serving cell that may be used to each trigger an A-CSI report for a set of CCs of a CG as described previously.

In some embodiments, eNB 110 may not transmit CC index(es) of a combination to reduce signaling overhead. For example, one or more rules may be specified to implicitly associate one or more CCs with a CC set for an A-CSI report.

For example, eNB 110 may configure a CC “k” to trigger an A-CSI report for a (k+1)th set of serving cell(s) or CC(s), where k=N mod L, e.g., as described previously. For example, N may denote a number of CCs configured for UE 120 by higher layers and/or and L may denote a total number of CC sets configured for UE 120 by higher layers. In some embodiments, eNB 110 may configure k, N and/or L and/or for which set of serving cells or CCs an A-CSI report is triggered, e.g., (k+1)th set of CCs, etc., via RRC.

For another example, eNB 110 may configure an A-CSI report trigger mechanism independently for each CG. For example, eNB 110 may configure a CSI request field with a respective value (e.g. “10” or “11”), any serving cell in the CG ‘X’ may trigger an A-CSI report for a set of CCs within the CG ‘X’. For example, eNB 110 may configure a respective CSI request field in an uplink DCI format to trigger an A-CSI report. In some embodiments, UE 120 may perform the A-CSI report for one or more serving cells of an associated CG in response to decoding the uplink DCI format to schedule a PUSCH on any serving cell within the CG (e.g., Option 2) or in response to decoding the uplink DCI format transmitted on any serving cell within the CG (Option 1). In some embodiments, eNB 110 may not support A-CSI report cross one or more CGs.

In some embodiments, for UE 120 that is configured in TM10 for at least one serving cell and/or that is not configured with CSI subframe sets for any serving cell, eNB 110 may extend an A-CSI report trigger configuration as described previously to UE 120. For example, eNB 110 may replace the “set of serving cells” in Table 1 by “set of CSI process(es)” for each combination of <serving cell ‘c’, CSI request field value ‘M’> to trigger an A-CSI report for the set of CSI process(es), e.g., via configuration module 130.

For example, eNB 110 may configure a combination of <CC1 in CG1, 10> to trigger an A-CSI report for a first set of CSI process(es) of CG1. For another example, a combination of <CC1 in CG1, 11> may be configured by higher layers to trigger an A-CSI report for a second set of CSI process(es) of CG1, etc. In some embodiments, eNB 110 may configure other combination to trigger an A-CSI report for a set of one or more CSI processes associated with other CG.

In some embodiments, the eNB 110 may configure, for the A-CSI report, another association between another set of CCs and another combination of the serving cell and another value of the CSI request field.

In some embodiments, the eNB 110 may configure, for the A-CSI report, another association between another set of CCs and another combination of another serving cell and the value of the CSI request field.

In some other embodiments, for UE 120 that is configured in TM10 for at least one serving cell and/or that is configured with one or more CSI subframe sets for at least one serving cell, eNB 110 may use an A-CSI report trigger configuration, e.g., as described previously. For example, eNB 110 may replace the “set of serving cells” in Table 1 by “set of CSI process(es) and/or {CSI process(es), CSI subframe set} pair(s)” for each combination of <serving cell ‘c’, CSI Request field value ‘M’> to trigger an A-CSI report for the set of CSI process(es) and/or {CSI process(es), CSI subframe set} pair(s), e.g., via the configuration module 130.

In some embodiments, eNB 110 may configure an A-CSI report trigger configuration for UE 120 that is configured with more than X CGs, e.g., X=2, which may not be required in some embodiments. In some other embodiments, eNB 110 may configure an A-CSI report trigger configuration for UE 120 that may not receive more than one aperiodic CSI report requests for a subframe, which may not be required in some embodiments.

In some embodiments, eNB 110 may configure an association between a set of CC(s) or CSI process(es) or pair(s) of <CSI process(es), subframe set(s)> for an aperiodic CSI feedback/report and a combination of the serving cell information and/or the value of the CSI request field. In some embodiments, eNB 110 may configure an association between a set of CC(s) or CSI process(es) or pair(s) of <CSI process(es), subframe set(s)> for an aperiodic CSI feedback/report and the serving cell.

In some embodiments, eNB 110 may configure the uplink DCI format to schedule a PUSCH transmission for an A-CSI report on a serving cell.

Referring to FIG. 5, at 504, in some embodiments, eNB 110 may transmit a PDCCH to carry an uplink DCI format that may comprise a CSI request field, e.g., via transmitter 112. In some embodiments, the CSI request field may comprise a value that may be configure by eNB 110, e.g., as described preciously with regard to 502. In some embodiments, eNB 110 may transmit the PDCCH with the uplink DCI format on a serving cell.

Referring to FIG. 5, at 506, in some embodiments, UE 120 may receive, e.g., via receiver 124, the PDCCH with the uplink DCI format from eNB 110 and/or may decode, e.g., via decoder 132, the uplink DCI format to obtain the value of the CSI request field in the uplink DCI format. In some embodiments, UE 120 may decode the uplink DCI format to detect on which serving cell the PDCCH with the uplink DCI format is transmitted to obtain the serving cell information, e.g., in Option 2. In some embodiments, UE 120 may decode the uplink DCI format to detect on which serving cell the PUSCH transmission with the aperiodic CSI request report is scheduled to obtain the serving cell information, e.g., in Option 1. In some embodiments, uplink DCI format may indicate on which serving cell the PUSCH transmission with the aperiodic CSI request report is scheduled by using an information element field (IE).

In some embodiments, at 506, UE 120 may determine, e.g., via determination module 134, one or more of CC(s) in CG(s) or CSI process(es), and/or pair(s) of <CSI process(es), CSI subframe set(s)> to perform an aperiodic CSI report based on serving cell information and/or the value of the CSI request field in response to detecting or receiving the uplink DCI format from eNB 110. For example, UE 120 may determine one or more of {CSI process(es), CC(s) in CG(s), CSI subframe set(s)} to perform an aperiodic CSI report based on a combination of the serving cell information and the value of the CSI request field.

In some embodiments, the serving cell information may relate to a serving cell where an aperiodic CSI report is transmitted, e.g., on PUSCH, based on the detected uplink DCI format (e.g., in Option 1) and/or a serving cell where PDCCH to carry the detected uplink DCI format is transmitted (e.g., in Option 2).

In some embodiments, UE 120 may determine one or more serving cells (or CCs) to perform an A-CSI report, e.g., based on a combination of serving cell information of Option 1 or Option 2 and/or a value of a CSI quest field in the uplink DCI format, e.g., in Table 1. In some embodiments, UE 120 may determine one or more serving cells or CCs to perform an A-CSI report based on, e.g., one or more combinations of <CC “x”, 10>, <CC “x”, 11>, <CC “y”, 10>, and <CC “y”, 11> or the like that may be configured by eNB 110 as described previously.

In some embodiments, UE 120 may determine a CC set of a CG to perform an A-CSI report based on a combination of <One Serving cell, one value of CSI request field>. For example, UE 120 may determine one or more serving cells or CCs to perform an A-CSI report based on, e.g., one or more combinations of <CC1 in CG1, 10>, <CC1 in CG1, 11>, <CC2 in CG1, 10>, and <CC2 in CG1, 11> or the like that may be configured by eNB 110 as described previously.

In some embodiments, UE 120 may determine, e.g., a (k+1)th set of serving cells or CCs to perform an A-CSI report based on a CC “k”, where k=N mod L, N may denote a number of CCs of UE 120 and L may denote a total number of CC sets for UE 120. In some embodiments, the CC “k”, N and/or L and/or a set of serving cells or CCs to perform the A-CSI report may be configured by eNB 110.

In some other embodiments, UE 120 may determine a set of serving cells to perform an A-CSI report based on a respective value of a CSI request field for each CG, e.g., for any serving cell in a CG ‘X’ that may trigger an A-CSI report for a set of serving cells or CCs within the CG ‘X’, e.g., in response to decoding the uplink DCI format to schedule a PUSCH on any serving cell within the CG “X” (e.g., Option 2) or in response to decoding the uplink DCI format transmitted on any serving cell within the CG “X” (Option 1).

In some embodiments, if UE 120 that is configured in TM 10 for at least one serving cell and/or is not configured with CSI subframe sets for any serving cell, UE 120 may determine a set of one or more CSI process(es) to perform an A-CSI report based on each combination of <serving cell ‘c’, CSI request field value ‘M’>, e.g., as described previously. For example, UE 120 may determine a first set of CSI process(es) of CG1 to perform an A-CSI report based on a combination of <CC1 in CG1, 10> and/or determine a second set of CSI processes of CG 2 to perform an A-CSI report based on a combination of <CC1 in CG1, 11>, e.g., in the uplink DCI format as described previously.

In some other embodiments, for UE 120 that is configured in TM10 for at least one serving cell and/or that is configured with one or more CSI subframe sets for at least one serving cell, UE 120 may determine a set of one or more CSI process(es) and/or one or more pairs of {CSI process(es), CSI subframe set} to perform an A-CSI report based on each combination of <serving cell ‘c’, CSI Request field value ‘M’>.

In some embodiments, UE 120 may be configured not to receive more than one aperiodic CSI report requests for a subframe, which may not be required.

In some embodiments, UE 120 may determine a set of CC(s) or CSI process(es) or pair(s) of <CSI process(es), subframe set(s)> for an aperiodic CSI feedback/report based on a combination of the serving cell information and/or the value of the CSI request field. In some embodiments, an association between a set of CC(s) or CSI process(es) or pair(s) of <CSI process(es), subframe set(s)> for an aperiodic CSI feedback/report and the serving cell information.

In some embodiments, UE 120 may determine a set of CC(s) or CSI process(es) or pair(s) of <CSI process(es), subframe set(s)> for an aperiodic CSI feedback/report based on a combination of the serving cell information and/or the value of the CSI request field in response to decoding the uplink DCI format to schedule a PUSCH transmission for an A-CSI report on the serving cell that may be configured by eNB 110.

In some embodiments, UE 120 may determine a set of CC(s) or CSI process(es) or pair(s) of <CSI process(es), subframe set(s)> for an aperiodic CSI feedback/report based on a combination of the serving cell information and/or the value of the CSI request field, for example <a serving cell, a value of CSI request field>, in response to decoding the uplink DCI format transmitted on the serving cell that may be configured by eNB 110.

UE 120 may determine one or more serving cells or CCs to perform an A-CSI report, e.g., based on a combination of information on a serving cell and/or a value of a CSI quest field in the uplink DCI format, e.g., in Table 1.

Referring to FIG. 5, at 508, UE 120 may transmit one or more aperiodic CSI reports for the associated set of CC(s) or CSI process(es) or pair(s) of <CSI process(es), CSI subframe set> based on the detected uplink DCI format, e.g., via the transmitter 122.

While the processes of FIG. 5 are illustrated to comprise a sequence of processes, the processes in some embodiments may be performed in a different order.

Embodiments described herein may be implemented into a system using any suitably configured hardware, software and/or firmware. FIG. 6 illustrates, for one embodiment, an example system comprising radio frequency (RF) circuitry 630, baseband circuitry 620, application circuitry 610, front end module (FEM) circuitry 660, memory/storage 640, one or more antennas 650, coupled with each other at least as shown. For one embodiment, FIG. 6 illustrates example components of a UE device 600 in accordance with some embodiments.

The application circuitry 610 may include one or more application processors. For example, the application circuitry 610 may include circuitry such as, but not limited to, one or more single-core or multi-core processors. The processor(s) may include any combination of general-purpose processors and dedicated processors (e.g., graphics processors, application processors, etc.). The processors may be coupled with and/or may include memory/storage and may be configured to execute instructions stored in the memory/storage to enable various applications and/or operating systems to run on the system.

The baseband circuitry 620 may include circuitry such as, but not limited to, one or more single-core or multi-core processors. The baseband circuitry 620 may include one or more baseband processors and/or control logic to process baseband signals received from a receive signal path of the RF circuitry 630 and to generate baseband signals for a transmit signal path of the RF circuitry 630. Baseband processing circuitry 620 may interface with the application circuitry 610 for generation and processing of the baseband signals and for controlling operations of the RF circuitry 630. For example, in some embodiments, the baseband circuitry 620 may include a second generation (2G) baseband processor, a third generation (3G) baseband processor, a fourth generation (4G) baseband processor, and/or other baseband processor(s) 620d for other existing generations, generations in development or to be developed in the future (e.g., fifth generation (5G), 6G, etc.). The baseband circuitry 620 (e.g., one or more of baseband processors) may handle various radio control functions that enable communication with one or more radio networks via the RF circuitry 630. The radio control functions may include, but are not limited to, signal modulation/demodulation, encoding/decoding, radio frequency shifting, etc. In some embodiments, modulation/demodulation circuitry of the baseband circuitry 620 may include Fast-Fourier Transform (FFT), precoding, and/or constellation mapping/demapping functionality. In some embodiments, encoding/decoding circuitry of the baseband circuitry 620 may include convolution, tail-biting convolution, turbo, Viterbi, and/or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 620 may include elements of a protocol stack such as, for example, elements of an EUTRAN protocol including, for example, physical (PHY), media access control (MAC), radio link control (RLC), packet data convergence protocol (PDCP), and/or RRC elements. A central processing unit (CPU) of the baseband circuitry 620 may be configured to run elements of the protocol stack for signaling of the PHY, MAC, RLC, PDCP and/or RRC layers. In some embodiments, the baseband circuitry 620 may include one or more audio digital signal processor(s) (DSP) that may include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 620 and the application circuitry 610 may be implemented together such as, for example, on a system on a chip (SOC).

In some embodiments, the baseband circuitry 620 may provide for communication compatible with one or more radio technologies. For example, in some embodiments, the baseband circuitry 620 may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry 620 is configured to support radio communications of more than one wireless protocol may be referred to as multi-mode baseband circuitry.

RF circuitry 630 may enable communication with wireless networks using modulated electromagnetic radiation through a non-solid medium. In various embodiments, the RF circuitry 630 may include switches, filters, amplifiers, etc. to facilitate the communication with the wireless network. RF circuitry 630 may include a receive signal path which may include circuitry to down-convert RF signals received from the FEM circuitry 660 and provide baseband signals to the baseband circuitry 620. RF circuitry 630 may also include a transmit signal path which may include circuitry to up-convert baseband signals provided by the baseband circuitry 620 and provide RF output signals to the FEM circuitry 660 for transmission.

In some embodiments, the RF circuitry 630 may include a receive signal path and a transmit signal path. The receive signal path of the RF circuitry 630 may include mixer circuitry, amplifier circuitry and/or filter circuitry. The transmit signal path of the RF circuitry 630 may include filter circuitry and/or mixer circuitry.

RF circuitry 630 may also include synthesizer circuitry for synthesizing a frequency for use by the mixer circuitry of the receive signal path and the transmit signal path. In some embodiments, the mixer circuitry of the receive signal path may be configured to down-convert RF signals received from the FEM circuitry 660 based on the synthesized frequency provided by synthesizer circuitry.

The amplifier circuitry may be configured to amplify the down-converted signals. The filter circuitry may be a low-pass filter (LPF) or band-pass filter (BPF) configured to remove unwanted signals from the down-converted signals to generate output baseband signals. Output baseband signals may be provided to the baseband circuitry 620 for further processing. In some embodiments, the output baseband signals may be zero-frequency baseband signals, although this is not a requirement. In some embodiments, mixer circuitry of the receive signal path may comprise passive mixers, although the scope of the embodiments is not limited in this respect.

In some embodiments, the mixer circuitry of the transmit signal path may be configured to up-convert input baseband signals based on the synthesized frequency provided by the synthesizer circuitry to generate RF output signals for the FEM circuitry 660. The baseband signals may be provided by the baseband circuitry 620 and may be filtered by filter circuitry. The filter circuitry may include a low-pass filter (LPF), although the scope of the embodiments is not limited in this respect.

In some embodiments, the mixer circuitry of the receive signal path and the mixer circuitry of the transmit signal path may include two or more mixers and may be arranged for quadrature downconversion and/or upconversion respectively. In some embodiments, the mixer circuitry of the receive signal path and the mixer circuitry of the transmit signal path may include two or more mixers and may be arranged for image rejection (e.g., Hartley image rejection). In some embodiments, the mixer circuitry of the receive signal path and the mixer circuitry may be arranged for direct downconversion and/or direct upconversion, respectively. In some embodiments, the mixer circuitry of the receive signal path and the mixer circuitry of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 630 may include analog-to-digital converter (ADC) and digital-to-analog converter (DAC) circuitry and the baseband circuitry 620 may include a digital baseband interface to communicate with the RF circuitry 630.

In some dual-mode embodiments, a separate radio IC circuitry may be provided for processing signals for each spectrum, although the scope of the embodiments is not limited in this respect.

In some embodiments, the synthesizer circuitry may be a fractional-N synthesizer or a fractional N/N+1 synthesizer, although the scope of the embodiments is not limited in this respect as other types of frequency synthesizers may be suitable. For example, synthesizer circuitry may be a delta-sigma synthesizer, a frequency multiplier, or a synthesizer comprising a phase-locked loop with a frequency divider.

The synthesizer circuitry may be configured to synthesize an output frequency for use by the mixer circuitry of the RF circuitry 630 based on a frequency input and a divider control input. In some embodiments, the synthesizer circuitry may be a fractional N/N+1 synthesizer.

In some embodiments, frequency input may be provided by a voltage controlled oscillator (VCO), although that is not a requirement. Divider control input may be provided by either the baseband circuitry 620 or the applications processor 610 depending on the desired output frequency. In some embodiments, a divider control input (e.g., N) may be determined from a look-up table based on a channel indicated by the applications processor 610.

Synthesizer circuitry of the RF circuitry 630 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 630 may include an IQ/polar converter.

FEM circuitry 660 may include a receive signal path which may include circuitry configured to operate on RF signals received from one or more antennas 650, amplify the received signals and provide the amplified versions of the received signals to the RF circuitry 630 for further processing. FEM circuitry 660 may also include a transmit signal path which may include circuitry configured to amplify signals for transmission provided by the RF circuitry 630 for transmission by one or more of the one or more antennas 650.

In some embodiments, the FEM circuitry 660 may include a TX/RX switch to switch between transmit mode and receive mode operation.

The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 630). The transmit signal path of the FEM circuitry 660 may include a power amplifier (PA) to amplify input RF signals (e.g., provided by RF circuitry 630), and one or more filters to generate RF signals for subsequent transmission (e.g., by one or more of the one or more antennas 650.

In some embodiments, the UE 600 comprises a plurality of power saving mechanisms. If the UE 600 is in an RRC_Connected state, where it is still connected to the eNB as it expects to receive traffic shortly, then it may enter a state known as Discontinuous Reception Mode (DRX) after a period of inactivity. During this state, the device may power down for brief intervals of time and thus save power.

If there is no data traffic activity for an extended period of time, then the UE 600 may transition off to an RRC_Idle state, where it disconnects from the network and does not perform operations such as channel quality feedback, handover, etc. The UE 600 goes into a very low power state and it performs paging where again it periodically wakes up to listen to the network and then powers down again. The device cannot receive data in this state, in order to receive data, it must transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

In various embodiments, transmit circuitry, control circuitry, and/or receive circuitry discussed or described herein may be embodied in whole or in part in one or more of the RF circuitry 630, the baseband circuitry 620, FEM circuitry 660 and/or the application circuitry 610. As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules or units.

In some embodiments, some or all of the constituent components of the baseband circuitry 620, the application circuitry 610, and/or the memory/storage may be implemented together on a system on a chip (SOC).

In some embodiments, the system may further comprise memory/storage that may be used to load and store data and/or instructions, for example, for the system. Memory/storage for one embodiment may include any combination of suitable volatile memory (e.g., dynamic random access memory (DRAM)) and/or non-volatile memory (e.g., Flash memory).

In various embodiments, the system may further comprise I/O interface that may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the system may further comprise sensor that may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the system may further comprise the display that may include a display (e.g., a liquid crystal display, a touch screen display, etc.).

In various embodiments, the system may be a mobile computing device such as, but not limited to, a laptop computing device, a tablet computing device, a netbook, an ultrabook, a smartphone, etc. In various embodiments, system may have more or less components, and/or different architectures.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules or units.

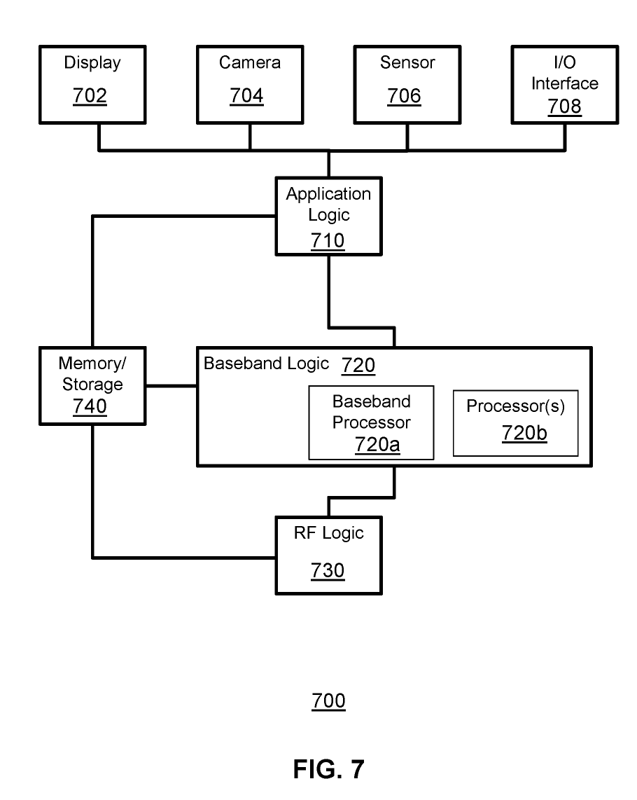

In some embodiments, embodiments described in FIG. 6 may be implemented in a system using any suitably configured hardware and/or software. FIG. 7 illustrates, for one embodiment, an example system comprising radio frequency (RF) logic 730, baseband logic 720, application logic 710, memory/storage 740, display 702, camera 704, sensor 706, and input/output (I/O) interface 708, coupled with each other at least as shown.

The application logic 710 may include one or more single-core or multi-core processors. The processor(s) may include any combination of general-purpose processors and dedicated processors (e.g., graphics processors, application processors, etc.). The processors may be coupled with memory/storage and configured to execute instructions stored in the memory/storage to enable various applications and/or operating systems running on the system.

The baseband logic 720 may include one or more single-core or multi-core processors. The processor(s) may include a baseband processor 720a and/or additional or alternative processors 720b that may be designed to implement functions or actions of the control logic, transmit logic, and/or receive logic described elsewhere herein. The baseband logic 720 may handle various radio control functions that enables communication with one or more radio networks via the RF logic. The radio control functions may include, but are not limited to, signal modulation, encoding, decoding, radio frequency shifting, etc. In some embodiments, the baseband logic 720 may provide for communication compatible with one or more radio technologies. For example, in some embodiments, the baseband logic may support communication with an evolved universal terrestrial radio access network (EUTRAN) and/or other wireless metropolitan area networks (WMAN), a wireless local area network (WLAN), a wireless personal area network (WPAN). Embodiments in which the baseband logic 720 is configured to support radio communications of more than one wireless protocol may be referred to as multi-mode baseband logic.

In various embodiments, baseband logic 720 may include logic to operate with signals that are not strictly considered as being in a baseband frequency. For example, in some embodiments, baseband logic 720 may include logic to operate with signals having an intermediate frequency, which is between a baseband frequency and a radio frequency.

In various embodiments, RF logic 730 may enable communication with wireless networks using modulated electromagnetic radiation through a non-solid medium. In various embodiments, the RF logic 730 may include switches, filters, amplifiers, etc. to facilitate the communication with the wireless network.

In various embodiments, RF logic 730 may include logic to operate with signals that are not strictly considered as being in a radio frequency. For example, in some embodiments, RF logic 730 may include logic to operate with signals having an intermediate frequency, which is between a baseband frequency and a radio frequency.

In various embodiments, transmit logic, control logic, and/or receive logic discussed or described herein may be embodied in whole or in part in one or more of the RF logic 730, the baseband logic, and/or the application logic. As used herein, the term “logic” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. Specifically, the logic may at be at least partially implemented in, or an element of, hardware, software, and/or firmware. In some embodiments, the electronic device logic may be implemented in, or functions associated with the logic may be implemented by, one or more software or firmware modules.

In some embodiments, some or all of the constituent components of the baseband logic, the application logic, and/or the memory/storage may be implemented together on a system on a chip (SOC).

Memory/storage 740 may be used to load and store data and/or instructions, for example, for system. Memory/storage 740 for one embodiment may include any combination of suitable volatile memory (e.g., dynamic random access memory (DRAM)) and/or non-volatile memory (e.g., Flash memory).

In various embodiments, the I/O interface 708 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, sensor 706 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband logic 720 and/or RF logic 730 to communicate with components of a positioning network, e.g., a global positioning system (GPS) satellite.

In various embodiments, the display 702 may include a display (e.g., a liquid crystal display, a touch screen display, etc.).

In various embodiments, the system may be a mobile computing device such as, but not limited to, a laptop computing device, a tablet computing device, a netbook, an ultrabook, a smartphone, etc. In various embodiments, system may have more or less components, and/or different architectures.

In various embodiments, the system may be a mobile computing device such as, but not limited to, a laptop computing device, a tablet computing device, a netbook, an ultrabook, a smartphone, etc. In various embodiments, system may have more or less components, and/or different architectures. For example, in some embodiments the RF logic 730 and/or the baseband logic 720 may be embodied in communication logic (not shown). The communication logic may include one or more single-core or multi-core processors and logic circuits to provide signal processing techniques, for example, encoding, modulation, filtering, converting, amplifying, etc., suitable to the appropriate communication interface over which communications will take place. The communication logic may communicate over wireline, optical, or wireless communication mediums. In embodiments in which the system is configured for wireless communication, the communication logic may include the RF logic 730 and/or baseband logic 720 to provide for communication compatible with one or more radio technologies. For example, in some embodiments, the communication logic may support communication with an evolved universal terrestrial radio access network (EUTRAN) and/or other wireless metropolitan area networks (WMAN), a wireless local area network (WLAN), a wireless personal area network (WPAN).

Embodiments of the technology herein may be described as related to the third generation partnership project (3GPP) long term evolution (LTE) or LTE-advanced (LTE-A) standards. For example, terms or entities such as eNodeB (eNB), mobility management entity (MME), user equipment (UE), etc. may be used that may be viewed as LTE-related terms or entities. However, in other embodiments the technology may be used in or related to other wireless technologies such as the Institute of Electrical and Electronic Engineers (IEEE) 802.16 wireless technology (WiMax), IEEE 802.11 wireless technology (WiFi), various other wireless technologies such as global system for mobile communications (GSM), enhanced data rates for GSM evolution (EDGE), GSM EDGE radio access network (GERAN), universal mobile telecommunications system (UMTS), UMTS terrestrial radio access network (UTRAN), or other 2G, 3G, 4G, 5G, etc. technologies either already developed or to be developed. In those embodiments, where LTE-related terms such as eNB, MME, UE, etc. are used, one or more entities or components may be used that may be considered to be equivalent or approximately equivalent to one or more of the LTE-based terms or entities.

### Examples

Example 1 may comprise an apparatus of a user equipment (UE), comprising: a decoder to decode uplink downlink control information (DCI) transmitted in a first serving cell to determine a value of a channel state information (CSI) request field; and determination circuitry to determine, for an aperiodic CSI report/feedback to be transmitted in a second serving cell, a set of component carriers (CCs), a CSI process, or a CSI subframe set based on the value and the first or second serving cells.

Example 2 may comprise the subject matter of Example 1 or some other examples herein, further comprising: group circuitry to maintain group information on one or more serving cells to be grouped into one or more cell groups (CGs), wherein the first or second serving cell is in a first CG.

Example 3 may comprise the subject matter of Examples 1 or 2 or some other examples herein, wherein the determination circuitry is to further: determine a corresponding CG in the one or more CGs to perform the aperiodic CSI report/feedback based on an association between the first or second serving cell and a corresponding CG triggered for the aperiodic CSI report/feedback.

Example 4 may comprise the subject matter of any one of Examples 1 to 3 or some other examples herein, further comprising: a transceiver to transmit the aperiodic CSI report/feedback on a physical uplink shared channel (PUSCH) transmission in the second serving cell based on the uplink DCI.

Example 5 may comprise the subject matter of any one of Examples 1 to 4 or some other examples herein, wherein the decoder is to further decode the uplink DCI to detect the second serving cell to transmit the aperiodic CSI report/feedback.

Example 6 may comprise the subject matter of any one of Examples 1 to 5 or some other examples herein, wherein the transceiver is to further: transmit a physical uplink shared channel (PUSCH) to carry the aperiodic CSI report/feedback on the second serving cell.

Example 7 may comprise the subject matter of any one of Examples 1 to 6 or some other examples herein, wherein determination circuitry is to further: determine a combination of CSI process(es) and a CSI subframe set(s) for the aperiodic CSI report/feedback based on the value and the first or second serving cell.

Example 8 may comprise the subject matter of any one of Examples 1 to 7 or some other examples herein, wherein the determination circuitry is to further: determine a cell group (CG) for the aperiodic CSI report/feedback based on the value and the first or second serving cell, wherein the cell group comprises the set of CCs.

Example 9 may comprise the subject matter of any one of Examples 1 to 8 or some other examples herein, wherein the determination circuitry is to further: determine the set of CCs for the aperiodic CSI report/feedback based on the value and the first serving cell.

Example 10 may comprise the subject matter of any one of Examples 1 to 9 or some other examples herein, wherein the determination circuitry is to further: access configuration information that associates a plurality of combinations of serving cells and values of CSI request fields to a corresponding plurality of sets of CCs, CSI processes, or CSI subframe sets; and determine, for the aperiodic CSI report/feedback, the set of CCs, the CSI process, or the CSI subframe set based on the configuration information.

Example 11 may comprise one or more computer-readable media having instructions that, when executed, cause a user equipment (UE) to: determine a value of a channel state request field in uplink downlink control information (DCI) received by the UE; determine service cell information based on a first serving cell having a physical downlink channel (PDCCH) that conveys the uplink DCI or a second serving cell in which an aperiodic channel state information (CSI) report/feedback is to be transmitted according to the DCI; and determine, based on the value and the serving cell information, component cells in a cell group, a CSI process, or a CSI subframe set to be used to generate CSI for the aperiodic CSI report/feedback.

Example 12 may comprise the subject matter of Example 11 or some other examples herein, wherein the first serving cell and the second serving cell are the same serving cell.

Example 13 may comprise the subject matter of any one of Examples 11 or 12 or some other examples herein, wherein the channel state request field comprises two bits.

Example 14 may comprise the subject matter of any one of Examples 11 to 13 or some other examples herein, wherein the instructions, when executed, further cause the UE to associate a plurality of combinations of channel state request values and serving cells with a respective plurality of sets of CCs, CSI processes, and/or CSI subframe sets.

Example 15 may comprise a base station system, comprising: A base station system, comprising: configuration circuitry to configure, for a aperiodic channel state information (A-CSI) report/feedback, an association between a set of component carriers (CCs), a CSI process, or a CSI subframe set and a combination of a serving cell and a value of a CSI request field in uplink downlink control information (DCI); and a transceiver to transmit the uplink DCI to a user equipment, wherein the uplink DCI or the A-CSI report/feedback is to be transmitted on the serving cell.

Example 16 may comprise the subject matter of Example 15 or some other examples herein, wherein the uplink DCI is to indicate that the A-CSI report/feedback is to be transmitted on the serving cell.

Example 17 may comprise the subject matter of any one of Examples 15 or 16 or some other examples herein, wherein the configuration circuitry is to further: configure the value of the CSI request field to indicate, in conjunction with the serving cell, a trigger of the A-CSI report/feedback for the set of CCs.

Example 18 may comprise the subject matter any one of Examples 15 to 17 or some other examples herein, wherein both the uplink DCI and the A-CSI report/feedback are to be transmitted on the serving cell.

Example 19 may comprise the subject matter of any one of Examples 15 to 18 or some other examples herein, wherein the serving cell is a first serving cell, the uplink DCI is transmitted on the first serving cell, and the transceiver is to further: transmit the A-CSI report/feedback on a PUSCH transmission on a second serving cell that is different from the first serving cell Example 20 may comprise the subject matter of any one of Examples 15 to 19 or some other examples herein, wherein the configuration module is to further: configure the value of the CSI request field to have a value of 10 or 11 to trigger the A-CSI report/feedback for the set of CCs.

Example 21 may comprise the subject matter of any one of Examples 15 to 20 or some other examples herein, wherein a total number of CC sets for the UE is L and the configuring circuitry is to further: configure respective associations between a plurality of CC sets and a plurality of combinations of serving cell(s) and CSI request value(s).

Example 22 may comprise the subject matter of any one of Examples 15 to 21 or some other examples herein, wherein the configuring module is to further: configure the association between the set of CCs and the combination of the serving cell and the value of the CSI request field to trigger the A-CSI report/feedback for the set of CCs.

Example 23 may comprise the subject matter of any one of Examples 15 to 22 or some other examples herein, wherein the configuring module is to further: configure the association between one or more CSI processes and the combination of the serving cell and the value of the CSI request field to trigger the A-CSI report/feedback for the one or more CSI processes.

Example 24 may comprise the subject matter of any one of Examples 15 to 23 or some other examples herein, wherein the combination is a first combination and the configuration circuitry is to further: configure the association between a second combination, which includes a CSI process and a CSI subframe set, and the first combination of the serving cell and the value of the CSI request field to trigger the A-CSI report/feedback for the second combination the CSI process and the CSI subframe set.

Example 25 may comprise the subject matter of any one of Examples 15 to 24 or some other examples herein, wherein the configuration module is to further: configure, for the A-CSI report/feedback, another association between another set of CCs and another combination of the serving cell and another value of the CSI request field.

Example 26 may comprise the subject matter of any one of Examples 15 to 25 or some other examples herein, wherein configure, for the A-CSI report/feedback, another association between another set of CCs and another combination of another serving cell and the value of the CSI request field.

Example 27 may comprise a user equipment (UE), comprising: a decoder to decode uplink downlink control information (DCI) transmitted in a first serving cell to determine a value of a channel state information (CSI) request field; and determination circuitry to determine, for an aperiodic CSI report/feedback to be transmitted in a second serving cell, a set of component carriers (CCs), a CSI process, or a CSI subframe set based on the value of the CSI request field and the first or second serving cells.

Example 28 may comprise the subject matter of Example 27 or some other examples herein, further comprising: a transceiver to receive the uplink DCI from an evolved node B (eNB) and to transmit the aperiodic CSI report/feedback to the eNB based on the uplink DCI.

Example 29 may comprise the subject matter of any one of Examples 27 or 28 or some other examples herein, further comprising: group circuitry to group the first set of CCs into a cell group (CG), wherein the first serving cell utilizes a first CC that is in the CG.

Example 30 may comprise the subject matter of any one of Examples 27 to 29 or some other examples herein, wherein the decoder is to further: decode the uplink DCI to detect the second serving cell to transmit the aperiodic CSI report/feedback.

Example 31 may comprise the subject matter of any one of Examples 27 to 30 or some other examples herein, wherein the transceiver is to further: transmit a physical uplink shared channel (PUSCH) to carry the aperiodic CSI report/feedback on the second serving cell.

Example 32 may comprise the subject matter of any one of Examples 27 to 31 or some other examples herein, wherein the determination circuitry is to: access configuration information that associates a plurality of combinations of serving cells and values of CSI request fields to a corresponding plurality of sets of CCs, CSI processes, or CSI subframe sets; and determine, for the aperiodic CSI report/feedback, the set of CCs, the CSI process, or the CSI subframe set based on the configuration information.

Example 33 may comprise the subject matter of any one of Examples 27 to 32 or some other examples herein, having instructions that, when executed, cause a user equipment (UE) to: determine a value of a channel state request field in uplink downlink control information (DCI) received by the UE; determine service cell information based on a first serving cell having a physical downlink channel (PDCCH) that conveys the uplink DCI or a second serving cell in which an aperiodic channel state information (CSI) report/feedback is to be transmitted according to the DCI; and determine, based on the value and the serving cell information, component cells in a cell group, a CSI process, or a CSI subframe set to be used to generate CSI for the aperiodic CSI report/feedback.

Example 34 may comprise the subject matter of any one of Examples 27 to 33 or some other examples herein, wherein the first serving cell and the second serving cell are the same serving cell.

Example 35 may comprise the subject matter of any one of Examples 27 to 34 or some other examples herein, wherein the channel state request field comprises two bits.

Example 36 may comprise the subject matter of any one of Examples 27 to 35 or some other examples herein, wherein the instructions, when executed, further cause the UE to associate a plurality of combinations of channel state request values and serving cells with a respective plurality of CSI reporting subjects.

Example 37 may include a method of wireless communication, comprising: determining, by a wireless device, a first set of component carriers (CCs) or channel state information (CSI) processes or pair of <CSI process(es), CSI subframe set> for aperiodic CSI feedback based on a combination of <a first serving cell, a first value of the CSI request field in a uplink downlink control information (DCI) format>; and transmitting, by the wireless device, the CSI reporting for the determined set of CCs or CSI processes or pair of <CSI process(es), CSI subframe set>.

Example 38 may include the method of example 37 or some other example herein, wherein the association between a first set of CCs or CSI processes or pair of <CSI process(es), CSI subframe set> for aperiodic CSI feedback and a first serving cell is configured by higher layer signaling.

Example 39 may include the method of examples 37 or 38 or some other example herein, wherein the first value of the CSI request field is either 10 or 11.

Example 40 may include the method of any one of examples 37 to 39 or some other example herein, wherein the association between a first serving cell and a first set of CCs or CSI processes or pair of <CSI process(es), CSI subframe set> for aperiodic CSI feedback is determined as follows: CC “k” can be used to trigger an aperiodic-CSI (A-CSI) report/feedback for (k+1)-th set of serving cells, where k=N mod L. N denotes the number of CCs and L is the total number of CCs set configured by a radio resource control (RRC) signal for a given UE.

Example 41 may include the method of any one of examples 37 to 40 or some other example herein, wherein the serving cells are first grouped into multiple cell groups (CGs) and a first serving cell is any serving cell within first CG.

Example 42 may include a wireless device comprising: control logic to determine a first set of component carriers (CCs) or channel state information (CSI) processes or pair of <CSI process(es), CSI subframe set> for aperiodic CSI feedback based on a combination of <a first serving cell, a first value of the CSI request field in a uplink downlink control information (DCI) format>; and transmit logic coupled with the control logic, the transmit logic to transmit the CSI reporting for the determined set of CCs or CSI processes or pair of <CSI process(es), CSI subframe set>.

Example 43 may include the wireless device of example 42 or some other example herein, wherein the association between a first set of CCs or CSI processes or pair of <CSI process(es), CSI subframe set> for aperiodic CSI feedback and a first serving cell is configured by higher layer signaling.

Example 44 may include the wireless device of examples 42 or 43 or some other example herein, wherein the first value of the CSI request field is either 10 or 11.

Example 45 may include the wireless device of any one of examples 42 to 44 or some other example herein, wherein the association between a first serving cell and a first set of CCs or CSI processes or pair of <CSI process(es), CSI subframe set> for aperiodic CSI feedback is determined as follows: CC “k” is used to trigger an aperiodic-CSI (A-CSI) report/feedback for (k+1)-th set of serving cells, where k=N mod L. N denotes the number of CCs and L is the total number of CCs set configured by a radio resource control (RRC) signal for a given UE.

Example 46 may include the wireless device of any one of examples 42 to 45 or some other example herein, wherein the serving cells are first grouped into multiple cell groups (CGs) and a first serving cell is any serving cell within first CG.

Example 47 may include an apparatus of a user equipment (UE), comprising: a decoder to decode an uplink downlink control information (DCI) format associated with the UE to detect a first serving cell with the uplink DCI format transmission or with a first aperiodic CSI report/feedback transmission triggered based on the uplink DCI format and a first value of a channel state information (CSI) request field in the uplink DCI format; and a circuitry to determine a first set of one or more component carriers (CCs) associated with the first aperiodic CSI report/feedback based on the first serving cell and the first value of the first CSI request field.

Example 48 may include the subject matter of example 47 or some other example herein, further comprising: a group module to maintain group information on one or more serving cells of the UE to be grouped into one or more cell groups (CGs), wherein the first serving cell is in a first CG.

Example 49 may include the subject matter of any one of examples 47 or 48 or some other example herein, wherein the circuitry is to further: determine a corresponding CG in the one or more CGs to perform the first aperiodic CSI report/feedback based on an association between the first serving cell and a corresponding CG triggered for the first aperiodic CSI report/feedback.

Example 50 may include the subject matter of any one of examples 47 to 49 or some other example herein, further comprising: a transceiver to transmit the first aperiodic CSI report/feedback on a PUSCH transmission based on the uplink DCI format detected by the decoding module.

Example 51 may include the subject matter of any one of examples 47 to 50 or some other example herein, wherein the circuitry is to further: determine a set of CSI processes for a second aperiodic CSI report/feedback based on the first serving cell and the first value of the first CSI request field in the detected uplink DCI format.

Example 52 may include the subject matter of any one of examples 47 to 51 or some other example herein, wherein the circuitry is to further: determine a combination of CSI process(es) and a CSI subframe set(s) for a third aperiodic CSI report/feedback based on the first serving cell and the first value of the first CSI request field in the detected uplink DCI format.

Example 53 may include the subject matter of any one of examples 47 to 52 or some other example herein, wherein the circuitry is to further: determine a first cell group (CG) for the first aperiodic CSI report/feedback based on the first serving cell and the first value of the first CSI request field, wherein the first cell group comprises one or more serving cells of the UE.

Example 54 may include the subject matter of any one of examples 47 to 53 or some other example herein, wherein the circuitry is to further: determine the first set of serving cells for the first A-CSI report/feedback based on a respective value of a CSI request field in the uplink DCI format and the first serving cell.

Example 55 may include the subject matter of any one of examples 47 to 54 or some other example herein, wherein the transceiver is to further: transmit a physical uplink shared channel (PUSCH) to carry one or more triggered A-CSI report/feedback on the first serving cell.

Example 56 may include a base station system, comprising: a configuration module to configure a first association between a first set of one or more component carriers (CCs) for a first aperiodic channel state information (A-CSI) report/feedback and a first combination of a first serving cell and a first value of a CSI request field in an uplink downlink control information (DCI) format; and a transceiver to transmit the uplink DCI format on the first serving cell to a user equipment.

Example 57 may include the subject matter of example 56 or some other example herein, wherein the first serving cell is the serving cell to transmit the first A-CSI report/feedback that is triggered based on the first serving cell and the first value of the CSI request field.

Example 58 may include the subject matter of any one of examples 56 or 57 or some other example herein, wherein the configuration module is to further: configure the first value of the CSI request field to indicate a trigger of the first A-CSI report/feedback for the first set of CCs that is associated with the first serving cell.

Example 59 may include the subject matter of any one of examples 56 to 58 or some other example herein, wherein the configuration module is to further configure a second association between the first set of CCs for the first A-CSI report/feedback and a second combination of a second serving cell and the first value of the CSI request field, wherein the second serving cell is the serving cell that is used for a transmission of the first A-CSI report/feedback.

Example 60 may include the subject matter of any one of examples 56 to 59 or some other example herein, wherein the transceiver is to further: transmit the first A-CSI report/feedback on a PUSCH transmission on the second serving cell.

Example 61 may include the subject matter of any one of examples 56 to 60 or some other example herein, wherein the configuring module is to further: configure the first value of the CSI request field to have a value of 10 or 11 to trigger the first A-CSI report/feedback for the first set of CCs associated with the first serving cell.

Example 62 may include the subject matter of any one of examples 56 to 61 or some other example herein, wherein the configuring module is to further: configure an association between a kth CC and a (k+1)th set of CCs to trigger an A-CSI report/feedback for the (k+1)th set of CCs by the kth CC, wherein k=N mod L, N to denote a number of CCs of the UE and L to denote a total number of CC sets for the UE.

Example 63 may include the subject matter of any one of examples 56 to 62 or some other example herein, wherein the configuration module is to further: configure the first serving cell and the first value of the first CSI request field to trigger an A-CSI report/feedback for a set of CCs associated with the first serving cell.

Example 64 may include the subject matter of any one of examples 56 to 63 or some other example herein, wherein the configuration module is to further: configure the first serving cell and the first value of the first CSI request field to trigger an A-CSI report/feedback for a set of CSI processes associated with the first serving cell.

Example 65 may include the subject matter of any one of examples 56 to 64 or some other example herein, wherein the configuration module is to further: configure the first serving cell and the first value of the first CSI request field to trigger an A-CSI report/feedback for a combination of one or more CSI process and a CSI subframe set associated with the first serving cell.

Example 66 may include the subject matter of any one of examples 56 to 65 or some other example herein, wherein the configuration module is to further: configure first serving cell and the first value of the first CSI request field to trigger the first aperiodic CSI report/feedback for one or more CCs in a cell group (CG) of the first set of CCs.

Example 67 may include the subject matter of any one of examples 56 to 66 or some other example herein, wherein the configuration module is to further: configure the first value of the first CSI request field to comprise a respective value for a cell group (CG) to trigger an aperiodic CSI report/feedback for a set of CCs in the CG via any CC of the CG.

Example 68 may include the subject matter of any one of examples 56 to 67 or some other example herein, wherein the configuration module is to further: configure the first value of the CSI request field for any serving cell in a cell group (CG) of the first set of CCs to trigger the first A-CSI report/feedback for a set of CCs within the CG.

Example 69 may include the subject matter of any one of examples 56 to 68 or some other example herein, wherein the configuration module is to further: configure the first serving cell and the first value of the CSI request field to trigger a second A-CSI report/feedback for a first set of CSI process(es) of a cell group (CG).

Example 70 may include the subject matter of any one of examples 56 to 69 or some other example herein, wherein the configuration module is to further: configure the first serving cell and the first value of the CSI request field to trigger a third A-CSI report/feedback for one or more pairs of one or more CSI processes and a CSI subframe set.

Example 71 may include an apparatus comprising means for performing one or more elements of a method described in or related to any of examples 1 to 70, or any other method or process described herein.

Example 72 may include one or more non-transitory computer-readable media comprising instructions to cause an electronic device, upon execution of the instructions by one or more processors of the electronic device, to perform one or more elements of a method described in or related to any of examples 1-70, or any other method or process described herein.

Example 73 may include an apparatus comprising control circuitry, transmit circuitry, and/or receive circuitry to perform one or more elements of a method described in or related to any of examples 1-70, or any other method or process described herein.

Example 74 may include a method of communicating in a wireless network as shown and described herein.

Example 75 may include a system for providing wireless communication as shown and described herein.

Example 76 may include a device for providing wireless communication as shown and described herein.

Example 77 may comprise one or more non-transitory computer-readable media comprising instructions to cause an electronic device, upon execution of the instructions by one or more processors of the mobile device, to perform one or more elements described in or related to any of examples 1 to 46, and/or any other method or process described herein.

Example 78 may comprise an apparatus comprising control circuitry, transmit circuitry, and/or receive circuitry to perform one or more elements of a method described in or related to any of examples 1-70 and/or any other method or process described herein.

Example 79 may include a method of communicating in a wireless network as shown and described herein and/or comprising one or more elements of an apparatus of a UE or a base station system described in or related to any of examples 1-70 and/or any other method or process described herein.

Example 80 may include a wireless communication system as shown and described herein and/or comprising one or more elements of an apparatus of a UE and/or a base station system described in or related to any of examples 1-70 and/or any other embodiments described herein.

Example 81 may include a wireless communication device as shown and described herein and/or comprising one or more elements of an apparatus of a UE and/or a base station system described in or related to any of examples 1-70 and/or any other embodiments described herein.

It should be understood that many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executable code of an identified module need not be physically located together, but may comprise disparate instructions stored in different locations which, when joined logically together, comprise the module and achieve the stated purpose for the module.

A module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Reference throughout this specification to “an example” means that a particular feature, structure, or characteristic described in connection with the example is comprised in at least one embodiment of the present disclosure. Thus, appearances of the phrases “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as an equivalent of any other member of the same list solely based on their presentation in a common group without indications to the contrary. In addition, various embodiments and example of the present disclosure may be referred to herein along with alternatives for the various components thereof. It is understood that such embodiments, examples, and alternatives are not to be construed as equivalents of one another, but are to be considered as separate and autonomous representations of the present disclosure.

Furthermore, the described features, structures, or characteristics may be combined in any suitable manner in one or more embodiments. In the following description, numerous specific details are provided, such as examples of search spaces, to provide a thorough understanding of embodiments of the disclosure. One skilled in the relevant art will recognize, however, that the embodiments may be practiced without one or more of the specific details, or with other methods, components, materials, etc. In other instances, well-known structures, materials, or operations are not shown or described in detail to avoid obscuring aspects of the disclosure.

While the forgoing examples are illustrative of the principles of the present disclosure in one or more particular applications, it will be apparent to those of ordinary skill in the art that numerous modifications in form, usage and details of implementation may be made without the exercise of inventive faculty, and without departing from the principles and concepts of the disclosure.

While certain features of the disclosure have been described with reference to embodiments, the description is not intended to be construed in a limiting sense. Various modifications of the embodiments, as well as other embodiments of the disclosure, which are apparent to persons skilled in the art to which the disclosure pertains are deemed to lie within the spirit and scope of the disclosure.

1.-25. (canceled)

26. An apparatus of a user equipment (UE), comprising:
a decoder to decode uplink downlink control information (DCI) transmitted in a first serving cell to determine a value of a channel state information (CSI) request field; and
a circuitry to determine, for an aperiodic CSI report or feedback to be transmitted in a second serving cell, a set of component carriers (CCs), a CSI process, or a CSI subframe set based on the value and the first or second serving cells.

27. The apparatus of claim 26, wherein the circuitry is to further:
maintain group information on one or more serving cells to be grouped into one or more cell groups (CGs), wherein the first or second serving cell is in a first CG.

28. The apparatus of claim 27, wherein the circuitry is to further:
determine a corresponding CG in the one or more CGs to perform the aperiodic CSI report based on an association between the first or second serving cell and a corresponding CG triggered for the aperiodic CSI report or feedback.

29. The apparatus of claim 26, further comprising:
a transceiver to transmit the aperiodic CSI report or feedback on a PUSCH transmission in the second serving cell based on the uplink DCI.

30. The apparatus of claim 29, wherein the transceiver is to further:
transmit a physical uplink shared channel (PUSCH) to carry the aperiodic CSI report or feedback on the second serving cell.

31. The apparatus of claim 26, wherein the decoder is to further decode the uplink DCI to detect the second serving cell to transmit the aperiodic CSI report or feedback.

32. The apparatus of claim 26, wherein the circuitry is to further:
determine a combination of CSI process(es) and a CSI subframe set(s) for the aperiodic CSI report based on the value and the first or second serving cell.

33. The apparatus of claim 26, wherein the circuitry is to further:
determine a cell group (CG) for the aperiodic CSI report or feedback based on the value and the first or second serving cell, wherein the cell group comprises the set of CCs.

34. The apparatus of claim 26, wherein the circuitry is to further:
determine the set of CCs for the aperiodic CSI report or feedback based on the value and the first serving cell.

35. The apparatus of claim 26, wherein the circuitry is to further:
access configuration information that associates a plurality of combinations of serving cells and values of CSI request fields to a corresponding plurality of sets of CCs, CSI processes, or CSI subframe sets; and
determine, for the aperiodic CSI report or feedback, the set of CCs, the CSI process, or the CSI subframe set based on the configuration information.

36. One or more non-transitory, computer-readable media having instructions that, when executed, cause a user equipment (UE) to:
determine a value of a channel state request field in uplink downlink control information (DCI) received by the UE;
determine service cell information based on a first serving cell having a physical downlink channel (PDCCH) that conveys the uplink DCI or a second serving cell in which an aperiodic channel state information (CSI) report or feedback is to be transmitted according to the DCI; and
determine, based on the value and the serving cell information, component cells in a cell group, a CSI process, or a CSI subframe set to be used to generate CSI for the aperiodic CSI report or feedback.

37. The one or more non-transitory, computer-readable media of claim 36, wherein the first serving cell and the second serving cell are the same serving cell.

38. The one or more non-transitory, computer-readable media of claim 36, wherein the channel state request field comprises two bits.

39. The one or more non-transitory, computer-readable media of claim 36, wherein the instructions, when executed, further cause the UE to associate a plurality of combinations of channel state request values and serving cells with a respective plurality of sets of CCs, CSI processes, and/or CSI subframe sets.

40. A base station system, comprising:
configuration circuitry to configure, for a aperiodic channel state information (A-CSI) report, an association between a set of component carriers (CCs), a CSI process, or a CSI subframe set and a combination of a serving cell and a value of a CSI request field in uplink downlink control information (DCI); and
a transceiver to transmit the uplink DCI to a user equipment, wherein the uplink DCI or the A-CSI report is to be transmitted on the serving cell.

41. The base station system of claim 40, wherein the uplink DCI is to indicate that the A-CSI report is to be transmitted on the serving cell.

42. The base station system of claim 40, wherein the configuration circuitry is to further:
configure the value of the CSI request field to indicate, in conjunction with the serving cell, a trigger of the A-CSI report for the set of CCs.

43. The base station system of claim 40, wherein both the uplink DCI and the A-CSI report are to be transmitted on the serving cell.

44. The base station system of claim 40, wherein the serving cell is a first serving cell, the uplink DCI is transmitted on the first serving cell, and the transceiver is to further:
transmit the A-CSI report on a PUSCH transmission on a second serving cell that is different from the first serving cell.

45. The base station system of claim 40, wherein the configuring circuitry is to further:
configure the value of the CSI request field to have a value of 10 or 11 to trigger the A-CSI report for the set of CCs.

46. The base station system of claim 40, wherein a total number of CC sets for the UE is L and the configuring circuitry is to further:
configure respective associations between a plurality of CC sets and a plurality of combinations of serving cell and CSI request values.

47. The base station system of claim 40, wherein the configuration circuitry is to configure the association between the set of CCs and the combination of the serving cell and the value of the CSI request field to trigger the A-CSI report for the set of CCs.

48. The base station system of claim 40, wherein the configuration circuitry is to:
configure the association between one or more CSI processes and the combination of the serving cell and the value of the CSI request field to trigger the A-CSI report for the one or more CSI processes.

49. The base station system of claim 40, wherein the combination is a first combination and the configuration circuitry is to:
configure the association between a second combination, which includes a CSI process and a CSI subframe set, and the first combination of the serving cell and the value of the CSI request field to trigger the A-CSI report for the second combination the CSI process and the CSI subframe set.

50. The base station system of claim 40, wherein the configuration circuitry is to further:
configure, for the A-CSI report, another association between another set of CCs and another combination of the serving cell and another value of the CSI request field.
